(19) United States
(12) Patent Application Publication
(10) Pub. No.: US 2025/0319971 A1
(43) Pub. Date: Oct. 16, 2025

(54) STRATOSPHERIC BALLOON CAPSULE TEMPERATURE & HUMIDITY CONTROL SYSTEM

(71) Applicant: Hamilton Sundstrand Corporation, Charlotte, NC (US)

(72) Inventors: Andrew Frosti, Vernon, CT (US); Diego S. Mugurusa, North Haven, CT (US); Oscar Jara, New Britain, CT (US); Svanik Shirodkar, Sterling, VA (US); Zippora Malka Cahn, Baltimore, MD (US)

(21) Appl. No.: 18/636,538

(22) Filed: Apr. 16, 2024

(51) Int. Cl. B64D 13/08; B64D 13/06

(52) U.S. Cl. CPC B64D 13/08; B64D 2013/064

(57) ABSTRACT

A stratospheric capsule includes: a capsule interior configured to enclose occupants during a stratospheric space flight; a capsule exterior; and an environmental control system (ECS) configured to control one or more of temperature and humidity in the capsule interior during the stratospheric space flight. The ECS includes: an internal air-cooling heat exchanger that cools air within the capsule by passing air across a cooling fluid within the ECS and a phase change material (PCM) heat exchange assembly located within the capsule interior. First and second valves are arranged and configured to be controlled based on the temperature measured by the temperature sensor measuring air passing through the internal air-cooling heat.

### BACKGROUND

Exemplary embodiments of the present disclosure pertain to the art of vehicle cabin temperature and humidity control.

Environmental controls are important in many environments (e.g., homes, businesses, vehicles). In an aircraft or space vehicle, cabin pressure must be controlled along with temperature and humidity.

One example of such an environment is capsule that may be used for so-called “space-tourism.” Such capsules may house civilian occupants and be lifted by stratospheric balloons. The environmental control system (ECS) for this capsule must provide a habitable atmosphere for passengers while the external environment pressure varies between ˜1 to ˜0.01 atm. and temperature varies between ˜100° F. to ˜−130° F. as the capsule flies between sea level and 100,000 ft. This unique environment doesn't lend itself to either aircraft or spacecraft thermal management solutions.

### BRIEF DESCRIPTION

Disclosed is a stratospheric capsule. The capsule includes: a capsule interior configured to enclose occupants during a stratospheric space flight; a capsule exterior; and an environmental control system (ECS) configured to control one or more of temperature and humidity in the capsule interior during the stratospheric space flight. The ECS includes: an internal air-cooling heat exchanger that cools air within the capsule with by passing air across a cooling fluid within the ECS; an external heat rejection assembly fluidly connected to the internal air-cooling heat exchanger and located on or outside of the capsule exterior, external heat rejection assembly configured to rejected heat from the cooling fluid to external air; a phase change material (PCM) heat exchange assembly located within the capsule interior and fluidly connected to the external heat rejection assembly and the internal air-cooling heat exchanger; a first temperature sensor that measures a temperature of air entering the internal air-cooling heat exchanger; a first valve disposed between the PCM heat exchange assembly and the internal air-cooling heat exchanger configured to control a flow of the cooling fluid through or around the internal air-cooling heat exchanger assembly based on the temperature measured by the temperature sensor; and a second valve disposed between the external heat rejection assembly and the PCM heat exchange assembly configured to control a flow of the cooling fluid through or around the PCM heat exchange assembly based on a temperature measured by the temperature sensor.

In addition to one or more of the features described above, or as an alternative to any of the foregoing embodiments, the capsule can further include a controller configured to receive the temperature measured by the temperature sensor and to control the first and second valves.

In addition to one or more of the features described above, or as an alternative to any of the foregoing embodiments, the controller can cause the opening of the first valve fully before the second valve is opened to thereby cause the cooling fluid to bypass the PCM heat exchange assembly until the first valve is fully open.

In addition to one or more of the features described above, or as an alternative to any of the foregoing embodiments, the second valve can be opened to allow a percentage of the cooling fluid passing through the PCM heat exchange assembly to increase until the temperature measured by the temperature sensor is at or below a desired temperature.

In addition to one or more of the features described above, or as an alternative to any of the foregoing embodiments, the capsule can further include: an external sensor configured to measure a temperature at or near the capsule exterior; and a coolant temperature sensor configured to measure a temperature of coolant fluid leaving the external heat rejection assembly.

In addition to one or more of the features described above, or as an alternative to any of the foregoing embodiments, the controller can be configured to cause a fan in the external heat rejection assembly to be disabled when the temperature measured by the external sensor exceeds the temperature of coolant fluid leaving the external heat rejection assembly.

In addition to one or more of the features described above, or as an alternative to any of the foregoing embodiments, the PCM heat exchange assembly can include a PCM in a solid form contained therein that can be melted to remove heat from the cooling fluid.

In addition to one or more of the features described above, or as an alternative to any of the foregoing embodiments, the controller can be configured to cause a fan in the external heat rejection assembly to be operated such that the temperature of coolant fluid leaving the external heat rejection assembly is lower than a temperature required to freeze the PCM in the PCM heat exchange assembly.

In addition to one or more of the features described above, or as an alternative to any of the foregoing embodiments, the controller can cause the opening of the second valve to cause the cooling fluid to pass through the PCM in the PCM heat exchange assembly when the temperature of coolant fluid leaving the external heat rejection assembly is lower than a temperature required to freeze the PCM in the PCM heat exchange assembly.

In addition to one or more of the features described above, or as an alternative to any of the foregoing embodiments, the sensor can further include a humidity sensor arranged in the internal air-cooling heat exchanger that measure humidity of air passing through the internal air-cooling heat exchanger and control a fan speed of a fan in the internal air-cooling heat exchanger based on the measured humidity.

Also disclosed is a method of controlling an environment within a stratospheric capsule. The method can be applied to any prior or otherwise disclosed system or capsule disclosed herein. In one embodiment, the method includes: measuring with a first temperature sensor a temperature of air entering the internal air-cooling heat exchanger that cools air within the capsule with by passing air across a cooling fluid within an environmental control system of the capsule; based on the measured temperature, opening a first valve disposed between a phase change material (PCM) heat exchange assembly and the internal air-cooling heat exchanger toto control a flow of the cooling fluid through or around the internal air-cooling heat exchanger, wherein the first valve is opened until it is fully opened; and opening a second valve disposed between the ECS and the PCM heat exchange assembly configured to control a flow of the cooling fluid through or around the PCM heat exchange assembly based on a temperature measured by the temperature sensor, wherein the first valve is fully opened before the second valve is opened to thereby cause the cooling fluid to bypass the PCM heat exchange assembly until the first valve is fully open.

In addition to one or more of the features described above, or as an alternative to any of the foregoing method embodiments, the method can further include: fully opening the second valve to allow a percentage of the cooling fluid passing through the PCM heat exchange assembly to increase until the temperature measured by the temperature sensor is at or below a desired temperature.

In addition to one or more of the features described above, or as an alternative to any of the foregoing method embodiments, the method can further include: providing an external heat rejection assembly at or near an exterior of the capule; and measuring a temperature at or near a capsule exterior with an external sensor configured and measuring with a coolant temperature sensor a temperature of coolant fluid leaving the external heat rejection assembly.

In addition to one or more of the features described above, or as an alternative to any of the foregoing method embodiments, the external heat rejection assembly can include a fan and the method can further include: disabling the fan when the temperature measured by the external sensor exceeds the temperature of coolant fluid leaving the external heat rejection assembly.

In addition to one or more of the features described above, or as an alternative to any of the foregoing method embodiments, the PCM heat exchange assembly can further include a PCM in a solid form contained therein that can be melted to remove heat from the cooling fluid. The method can further include: causing the fan in the external heat rejection assembly to be operated such that the temperature of coolant fluid leaving the external heat rejection assembly is lower than a temperature required to freeze the PCM in the PCM heat exchange assembly.

In addition to one or more of the features described above, or as an alternative to any of the foregoing method embodiments, the method can further include: opening the second valve to cause the cooling fluid to pass through the PCM in the PCM heat exchange assembly when the temperature of coolant fluid leaving the external heat rejection assembly is lower than a temperature required to freeze the PCM in the PCM heat exchange assembly.

In addition to one or more of the features described above, or as an alternative to any of the foregoing method embodiments, the method can further include: measuring with a humidity sensor arranged in the internal air-cooling heat exchanger humidity of air passing through the internal air-cooling heat exchanger; and controlling a fan speed of a fan in the internal air-cooling heat exchanger based on the measured humidity.

### BRIEF DESCRIPTION OF THE DRAWINGS

The following descriptions should not be considered limiting in any way. With reference to the accompanying drawings, like elements are numbered alike:

FIG. 1 is schematic showing a capsule combined with an environmental control system according to one embodiment;

FIG. 2 is a graph showing one manner which the internal valves can be controlled; and

FIG. 3 is a control diagram of controlling the valves of FIGS. 1 and 2.

### DETAILED DESCRIPTION

A detailed description of one or more embodiments of the disclosed apparatus and method are presented herein by way of exemplification and not limitation with reference to the Figures.

In some embodiments disclosed herein is a thermal control system that controls one or both of temperature and humidity in a capsule. The capsule can be used to move one or more occupant(s) from a ground location to a higher elevation (e.g., above 20 Km above the surface) and then stay in the higher elevation for an extended (e.g., 4+ hours) time period and then return to ground.

As will be understood, during such a flight the range of temperatures will vary dramatically. As such, the capsule will need a thermal control system that can keep the interior at a comfortable temperature/humidity of the range of temperatures.

In one embodiment, this can be accomplished by a control system that includes a pumped coolant loop that cools and dehumidifies cabin air through a cabin fan & heat exchanger (referred to as internal air-cooling heat exchanger below) and then rejects heat through a combination of an external heat rejection assembly and a phase change material (PCM) heat exchange assembly. The system can include a control system that dynamically manages the share of heat rejection between the external heat rejection assembly and the PCM heat exchange assembly during the flight via a set of coolant modulating valves. At low altitudes (ascent/descent) when the external air is warm, the PCM heat exchange assembly absorbs heat and thereby can be used to cool a coolant used in the internal air-cooling heat exchanger. At higher altitudes when the external air is cold, the external heat rejection assembly rejects capsule heat to the external air and refreezes the PCM in the PCM heat exchange assembly for use during descent. The system can also regulate cabin temperature and humidity independently by adjusting valve position and cabin fan speed.

In one of more embodiments, the use of an external and phase change HEX in a single control logic loop can provide better control over the range of altitudes/temperatures. In one embodiment, the system can utilize a cascaded control to give preference to the external heat rejection assembly and minimize the PCM used by PCM heat exchange assembly to keep the coolant and, thus, the air in the capsule at a particular level or within a temperature band/threshold. Since the external HEX can re-freeze the PCM in the PCM heat exchange assembly it improves the time the temperature control system can continuously operate. Further, by combining the external HEX with the cabin air temperature control simultaneous control of cabin air temperature and humidity can be achieved.

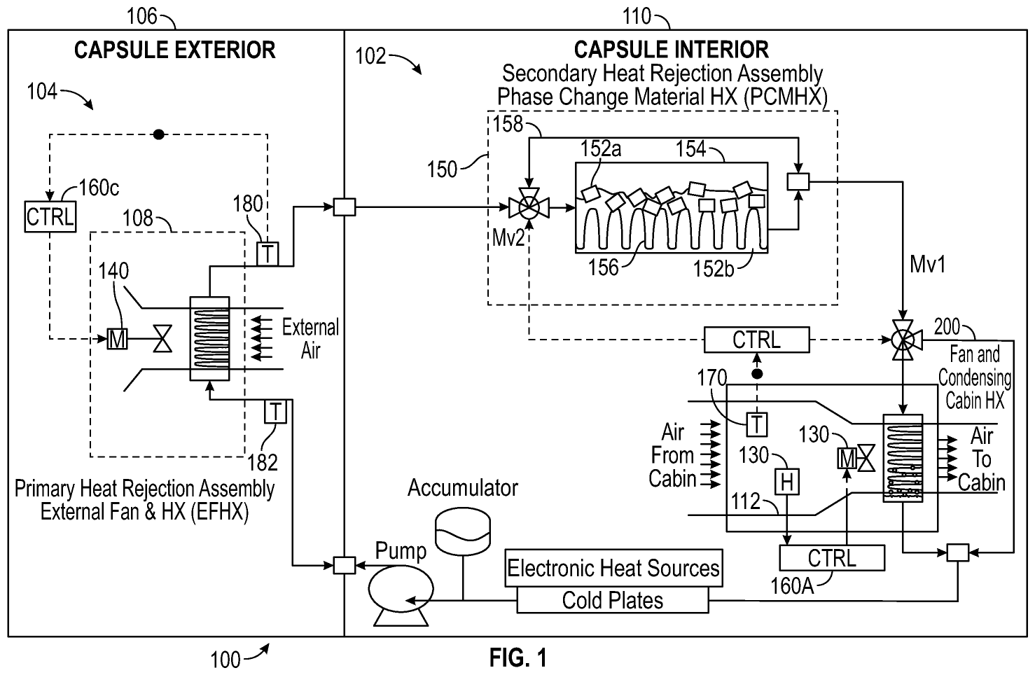

FIG. 1 shows an example of capsule 100 that includes an environmental control system according to one embodiment. The capsule 100 can be configured such that it can be attached to a source of lift such as a balloon that can lift and maintain the capsule at a stratospheric altitude (e.g., 20 km or more above the earth's surface). For clarity, the capsule 100 is illustrated as having an interior 102 and an exterior 104. The interior 102 can be a climate-controlled compartment of human or other live occupants. The exterior 104 can be exposed to an external environment directly or can have housing 106 that allows for airflow therethrough.

In one embodiment, the capsule 100 can be equipped with an environment control system (ECS) generally referred to by reference number 110 in FIG. 1. The disclosure herein covers both an ECS as a standalone unit that can be fitted to otherwise utilized by a capsule or that is in combination with combination with the capsule as shown in FIG. 1.

The portions of the ECS are shown as being connected by various connections that may be in the form, for example, of tubing/pipes. Certain aspects of the connections may be referred to in more detail below, but it shall be understood that the connections create a flow path of a coolant fluid. Examples of such fluids include refrigerant fluids that may include, for example, chlorofluorocarbons (CFCs) such as CFC-12, and hydrochlorofluorocarbons (HCFCs) such as HCFC-22, which is often referred to as R-22. Other examples include mixtures that include ethylene glycol or propylene glycol. Of course, these are just examples and any coolant could be used.

The ECS 110 includes two components that can be used to cool the coolant that is ultimately provided to/received from an internal air-cooling heat exchanger 112. The internal air-cooling heat exchanger 110 can be, for example, an a liquid/air heat exchanger that cools air within the capsule 110 with by passing air across tubes or other piping that includes the coolant fluid. The air has energy energy/heat from it by passing it over the coolant in the tubing. The exact configuration of the internal air-cooling heat exchanger 110 can vary but one example is shown in FIG. 1 and includes a fan 130 that drives air inside the capsule (e.g., air from cabin) across the tubing 132 that carries the coolant. The coolant can thereby remove energy/heat from the air and cool it.

The ECS 100 includes an external heat rejection assembly 108. The external heat rejection assembly 108 is fluidly connected to the internal air-cooling heat exchanger 112. The external heat rejection assembly 108 can be located on or outside of the capsule exterior 104. In one embodiment, the external heat rejection assembly 108 is contained within a housing 106. The external heat rejection assembly 108 can be configured to reject heat from the cooling fluid to external air. The exact configuration of the external heat rejection assembly 108 can vary but one example is shown in FIG. 1 and includes a fan 140 that draws external air across the tubing that carries the coolant. The air, if cold enough, can thereby remove energy/heat from the coolant.

The ECS also includes a phase change material (PCM) heat exchange assembly 150. The PCM heat exchange assembly 150 can be located within the capsule interior 102 in one embodiment. The PCM heat exchange assembly 150 can be fluidly connected to the external heat rejection assembly 108 and the internal air-cooling heat exchanger 112 and located between them in one embodiment. In operation, coolant leaving the external heat rejection assembly 108 can be cooled by the PCM heat exchange assembly 150 in one mode of operation such as when the capsule 100 is on the ground or at low altitude. In another mode (e.g., at high altitude when air external to the capsule 100 is cold), the coolant can be used to freeze some or all of the PCM in the PCM heat exchange assembly 150. In this manner, cooling capacity can be provided back to the PCM heat exchange assembly 150 during times when the capsule is descending back to ground. The PCM heat exchange assembly 150 can include both solid and liquid forms of the PCM material which is indicated in FIG. 1 by cubes and liquid portions 152a/152b respectively. The PCM material is enclosed in a housing 154 (PCM housing). The housing 154 can include tubes/pipes 156 that pass through it to provide a possible path from the coolant material to pass through the housing 154 and thermally interact with the PCM material 152a/152b therein. The PCM heat exchange assembly 150 also includes a PCM heat exchange assembly bypass 158 (PCM bypass) that provides coolant path around the housing 154 and is controlled by valve MV2 as more fully discussed below.

As shown, the ECS 110 includes a controller 160. The controller 160 can be formed as separate elements or as one element. For convenience, the controller 160 is shown as being distributed with controller 160a being associated with internal air-cooling heat exchanger 112, controller 160b being associated with PCM heat exchange assembly 150 and the internal air-cooling heat exchanger 112 via the first and second valves MV1/MV2 discussed below, and controller 160c being associated to the external heat rejection assembly 108.

The controller 160 controls at least two valves MV1 and MV2. This is based at least in part on information from a first temperature sensor 170 that measures a temperature of air entering the internal air-cooling heat exchanger 112.

The first valve MV1 can be arranged between the PCM heat exchange assembly 150 and the internal air-cooling heat exchanger 112. The first valve MV1 can be controlled so that it directs coolant either through the internal air-cooling heat exchanger 112 or an internal air-cooling heat exchanger bypass 200, or through both.

The second valve MV2 is disposed between the external heat rejection assembly 108 and the PCM heat exchange assembly 150 and control a flow of the cooling fluid through or around the PCM heat exchange assembly based on a temperature measured by the temperature sensor. In particular, the second valve MV2 can be controlled so that it directs coolant either through the PCM housing 154 or through the PCM bypass 158 depending on the cooling needs in the capsule and/or whether the PCM needs to be frozen for later use.

As noted above, PCM heat exchange assembly 150 and the external heat rejection assembly 108 can be used to provide for cooling of the coolant in the system as it is provided to the internal air-cooling heat exchanger 112. As noted above, the valves MV1/MV2 are arranged to allow for the coolant to be directed through the internal air-cooling heat exchanger 112/bypass 200 and/or housing 154 of the PCM heat exchange assembly 150 its bypass 158.

As noted above, the control of MV1/MV2 is based at least part on readings provided by the first temperature sensor 170 which measures a temperature of air entering the internal air-cooling heat exchanger 112. MV1 is disposed between the PCM heat exchange assembly 150 and the internal air-cooling heat exchanger 112 and control a flow of the cooling fluid through or around the internal air-cooling heat exchanger assembly 112 or through its bypass 200. If no cooling is needed, all of the coolant can bypass the internal air-cooling heat exchanger assembly 112 and flow completely through the through the bypass 200. As more cooling is needed, the MV1 can be commanded to pass more coolant through the internal air-cooling heat exchanger assembly 112 and less through its bypass.

To preserve solid PMC 152a in the housing 154, the controller 160b can cause MV1 to be opened to meet cooling needs while MV2 is closed (e.g., all coolant passes through bypass 158). MV2 can then be opened after MV1 is full opened to provide additional cooling if needed.

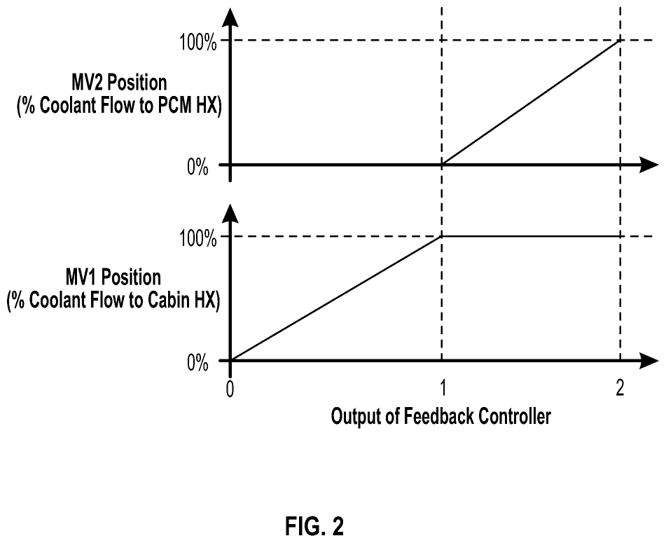

An example of the operating principle of controller 160b that prioritizes MV1 opening before MV2 to preserve solid PCM 152 in the housing is shown graphically in FIG. 2. In FIG. 2 the percentages related to position correspond the valve being fully opened (100%) where the coolant does not pass through a respective bypass and closed (0%) where the coolant passes entirely (or almost entirely) through a respective bypass.

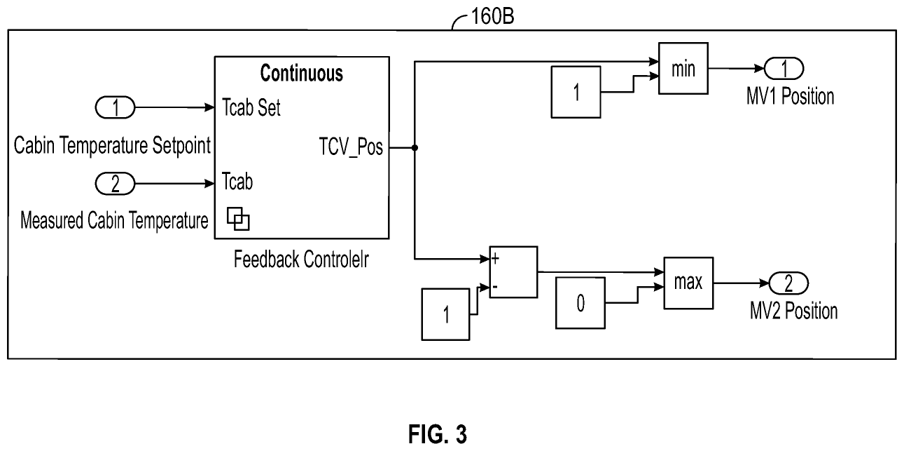

An example of a control algorithm that allows such operation to be achieved is shown in FIG. 3. The controller 160b can include feedback controller that receives a temperature set point (1) and a measured temperature (2). The measured temperature can be measured by sensor 170 (FIG. 1). Based on the difference between them a “cooling signal” can be generated that it shown by TCV_Pos in FIG. 3. The value can vary, for example, from 0 to 2. When the value is from 0-1 only MV1 will be opened. If the value is between 1 and 2, MV1 will be fully open and MV2 will be opened by an amount proportional to how much the value exceeds 1. Based on the above, it shall be understood that in one embodiment, the controller 160b opens the first valve MV1 fully before the second valve MV2 is opened to thereby cause the cooling fluid to bypass the PCM heat exchange assembly 150 until the first valve is fully open. Further, after the first valve is fully opened, the second valve MV2 can be opened to allow a percentage of the cooling fluid passing through the PCM heat exchange housing/assembly to increase until the temperature measured by the temperature sensor is at or below a desired temperature.

The above operation can occur, for example, when the capsule 100 is on the ground. In such a case, the external air passing through the external heat rejection assembly 108 may be higher than the desired capsule temperature (or at least high enough that it cannot effectively cool the coolant by itself without requiring access to the PCM heat exchange assembly. To that end, the system 110 also includes an external sensor 180 configured to measure a coolant temperature at or near the capsule exterior 104. As shown, the sensor 180 measures coolant temperature as the coolant leaves the external sensor 180.

Now consider the case where the capsule is gaining altitude. As the capsule rises, the external air gets cooler. At some point, the external temperature (as measured by optional sensor 182) falls below a desired coolant temperature. When that happens, the controller 160c can cause the fan 140 to operate to draw the cool air cover pipes 142 and thereby cool the coolant.

Eventually, the temperature measured by sensor 180 will be low enough that MV2 can begin to be closed. As temperatures fall even further, MV2 can be fully closed and the external heat rejection assembly 108 will provide all coolant cooling and MV1 can be used to control the coolant flow through the internal air-cooling heat exchanger assembly 112. In one embodiment, the controller 160c is configured to cause the fan 140 to be disabled when the temperature measured by the external sensor 182 exceeds the temperature of coolant fluid leaving the external heat rejection assembly 182 as measured by sensor 180.

As will be realized, at times (e.g., at stratospheric altitudes) the external heat rejection assembly 108 may be able to effectively cool the coolant such there is “excess cold” that can then be used to refreeze the coolant the housing. In such case, MV2 can then be opened either wholly or in part. In such a case, the system can be operating in a refreeze mode where MV1 controls internal temperature and MV2 is only opened/closed if the output temperate of the coolant measured by sensor 180 is below the freezing point of the PCM in the housing 154.

During flight, humidity may also need to be controlled. To that end, the controller 160a can receive a humidity reading from a humidity sensor 190 in the internal air-cooling heat exchanger assembly 112 and vary the fan 130 operation. Having the sensor 170 control MV1 and MV2 will thus integrate temperature and humidity control because changes in humidity will be reflected in the temperature measured by sensor 170.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is not intended that the present disclosure be limited to the particular embodiment disclosed as the best mode contemplated for carrying out this present disclosure, but that the present disclosure will include all embodiments falling within the scope of the claims.

What is claimed is:

1. A stratospheric capsule comprising:
a capsule interior configured to enclose occupants during a stratospheric space flight;
a capsule exterior; and
an environmental control system (ECS) configured to control one or more of temperature and humidity in the capsule interior during the stratospheric space flight, the ECS comprising:
an internal air-cooling heat exchanger that cools air within the capsule with by passing air across a cooling fluid within the ECS;
an external heat rejection assembly fluidly connected to the internal air-cooling heat exchanger and located on or outside of the capsule exterior, external heat rejection assembly configured to rejected heat from the cooling fluid to external air;
a phase change material (PCM) heat exchange assembly located within the capsule interior and fluidly connected to the external heat rejection assembly and the internal air-cooling heat exchanger;
a first temperature sensor that measures a temperature of air entering the internal air-cooling heat exchanger;
a first valve disposed between the PCM heat exchange assembly and the internal air-cooling heat exchanger configured to control a flow of the cooling fluid through or around the internal air-cooling heat exchanger assembly based on the temperature measured by the temperature sensor; and
a second valve disposed between the external heat rejection assembly and the PCM heat exchange assembly configured to control a flow of the cooling fluid through or around the PCM heat exchange assembly based on a temperature measured by the temperature sensor.

2. The capsule of claim 1, further comprising:
a controller configured to receive the temperature measured by the temperature sensor and to control the first and second valves.

3. The capsule of claim 2, wherein the controller opens the first valve fully before the second valve is opened to thereby cause the cooling fluid to bypass the PCM heat exchange assembly until the first valve is fully open.

4. The capsule of claim 3, wherein second valve is opened to allow a percentage of the cooling fluid passing through the PCM heat exchange assembly to increase until the temperature measured by the temperature sensor is at or below a desired temperature.

5. The capsule of claim 4, further comprising:
an external sensor configured to measure a temperature at or near the capsule exterior; and
a coolant temperature sensor configured to measure a temperature of coolant fluid leaving the external heat rejection assembly.

6. The capsule of claim 5, wherein the controller is configured to cause a fan in the external heat rejection assembly to be disabled when the temperature measured by the external sensor exceeds the temperature of coolant fluid leaving the external heat rejection assembly.

7. The capsule of claim 5, wherein the PCM heat exchange assembly includes a PCM in a solid form contained therein that can be melted to remove heat from the cooling fluid; and
wherein the controller is configured to cause a fan in the external heat rejection assembly to be operated such that the temperature of coolant fluid leaving the external heat rejection assembly is lower than a temperature required to freeze the PCM in the PCM heat exchange assembly.

8. The capsule of claim 7, wherein the controller opens the second valve to cause the cooling fluid to pass through the PCM in the PCM heat exchange assembly when the temperature of coolant fluid leaving the external heat rejection assembly is lower than a temperature required to freeze the PCM in the PCM heat exchange assembly.

9. The capsule of claim 8, further comprising:
a humidity sensor arranged in the internal air-cooling heat exchanger that measure humidity of air passing through the internal air-cooling heat exchanger and control a fan speed of a fan in the internal air-cooling heat exchanger based on the measured humidity.

10. A method of controlling an environment within a stratospheric capsule, the method comprising:
measuring with a first temperature sensor a temperature of air entering the internal air-cooling heat exchanger that cools air within the capsule with by passing air across a cooling fluid within an environmental control system of the capsule;
based on the measured temperature, opening a first valve disposed between a phase change material (PCM) heat exchange assembly and the internal air-cooling heat exchanger toto control a flow of the cooling fluid through or around the internal air-cooling heat exchanger, wherein the first valve is opened until it is fully opened; and
opening a second valve disposed between the ECS and the PCM heat exchange assembly configured to control a flow of the cooling fluid through or around the PCM heat exchange assembly based on a temperature measured by the temperature sensor, wherein the first valve is fully opened before the second valve is opened to thereby cause the cooling fluid to bypass the PCM heat exchange assembly until the first valve is fully open.

11. The method of claim 10, further comprising:
fully opening the second valve to allow a percentage of the cooling fluid passing through the PCM heat exchange assembly to increase until the temperature measured by the temperature sensor is at or below a desired temperature.

12. The method of claim 11, further comprising:
providing an external heat rejection assembly at or near an exterior of the capsule; and
measuring a temperature at or near a capsule exterior with an external sensor configured and measuring with a coolant temperature sensor a temperature of coolant fluid leaving the external heat rejection assembly.

13. The method of claim 12, wherein the external heat rejection assembly includes a fan and the method further includes:
disabling the fan when the temperature measured by the external sensor exceeds the temperature of coolant fluid leaving the external heat rejection assembly.

14. The method of claim 13, wherein the PCM heat exchange assembly includes a PCM in a solid form contained therein that can be melted to remove heat from the cooling fluid, the method further comprising:
causing the fan in the external heat rejection assembly to be operated such that the temperature of coolant fluid leaving the external heat rejection assembly is lower than a temperature required to freeze the PCM in the PCM heat exchange assembly.

15. The method of claim 14, further comprising:
opening the second valve to cause the cooling fluid to pass through the PCM in the PCM heat exchange assembly when the temperature of coolant fluid leaving the external heat rejection assembly is lower than a temperature required to freeze the PCM in the PCM heat exchange assembly.

16. The method of claim 15, further comprising:
measuring with a humidity sensor arranged in the internal air-cooling heat exchanger humidity of air passing through the internal air-cooling heat exchanger; and
controlling a fan speed of a fan in the internal air-cooling heat exchanger based on the measured humidity.
